(19) United States
(12) Patent Application Publication
(10) Pub. No.: US 2004/0202867 A1
(43) Pub. Date: Oct. 14, 2004

(54) Nanometer structured synthetic leather and its fabrication method

(76) Inventors: Chang-Cing Kuo, Ta-Tu-Hsiang (TW); Chun-Fu Chang, Ta-Tu-Hsiang (TW)

Correspondence Address: CHARLES E. BAXLEY, ESQUIRE, 59 John Street, Fifth Floor, New York, NY, 10038, US

(21) Appl. No.: 10/412,919

(22) Filed: Apr. 14, 2003

(51) Int. Cl. B32B 27/00

(52) U.S. Cl. 428/423.1; 528/44

(57) ABSTRACT

A nanometer structured synthetic leather fabrication method using the feature of hard segment of PU to be a nanometer structured material or the tie down point of other nanostructured materials to bond nanometer particles to PU molecular chains or to directly add nanometer structured particles to PU resins, forming a nanometer structured PU of modulus 100% within 60˜150 kg/cm².

### BACKGROUND OF THE INVENTION

1. Field of the Invention

The present invention relates to synthetic leather materials for handle grip and, more specifically, to a nanometer structured PU (synthetic) leather formed of polyurethane and nanostructured filler that shows high wear resisting power, fine and compact structure.

2. Description of the Related Art

“Nanometer” is a magical point on the dimensional scale. One nanometer is one billionth of a meter. It is about the length of 3 to 4 atoms connected in series that are invisible by the naked eyes. During the last few years, novel structures, phenomena, and processes have been observed at the nanoscale (from a fraction of nanometer to about 100 nm) and new experimental, theoretical and simulation tools have been developed for investigating them. These advances provide fresh opportunities for scientific and technological developments in nanoparticles, nanostructured materials, nanodevices, and systems (see Nanoscale Science and Engineering).

Currently, various nanostructured materials, such as nanometer structured carbon tube and nanometer particle clays have been developed. The difficulty in the application of nanometer materials is the dispersion of nanometer particles, i.e., the technique of controlling the arrangement of nanostructured particles. Due to the constraint of dispersion techniques, nanostructured particles cannot be evenly dispersed in materials. Therefore, the desired nanostructured products cannot be obtained, and nanostructured materials cannot provide the desired nanoscale engineering effect.

In the field of handle grip, PU (polyurethane) is commonly used. PU is a segmented copolymer having soft segments and hard segments. FIGS. 1 and 2 show the molecular structure of PU, in which reference number 1 indicates soft segments, reference number 2 indicates hard segments, and reference 3 indicates chain extender (a part of hard segment). PU is mainly composed of high molecular weight polyo (polyester, polyol etc.) (the soft segments) and diisocyanate, chain extender (the hard segments). Polyol can be polyester polyol or polyether polyol. Polyester polyol can be obtained from PEA (polyethylene adipate), PDEGA (polydiethylene glycol adipate), PBA (polybutylene adipate), or PCL (polycaprolactone). Polyether polyol can be obtained from PPG (polypropylene glycol), PTMG (polyetramethlene ether glycol), or PEG (polyethylene glycol. Diisocyanate can be obtained from H₁₂MDI, IPDI, HDI, CHDI, H₆XDI, MDI, TDI, PPDI, NDI, TODI, or PMDI. Chain extender can be diol or triol obtained from EG, BG, HG, or DEG, or diamine obtained from HZ or EDA.

Theoretically, it is the ideal ratio to compose PU with one Mole soft segment, one Mole chain extender, and two Moles hard segments. Modification may be made subject to this ratio. Normally, the modulus 100% of PU used for handle grip is below 40 kg/cm², preferably within 15˜30 kg/cm². Within this range, PU material is mole soft and elastic, however the ratio of hard segments is relatively low, resulting in low physical strength and low abrasron resistance Increasing the ratio of hard segments or reducing the ratio of soft segments relatively improve the structural strength, however PU material becomes relatively harder and tends to break, not suitable for handle grip application.

### SUMMARY OF THE INVENTION

The present invention has been accomplished under the circumstances in view. It is therefore the main object of the present invention to provide a nanometer structured synthetic leather, which provides nanometer physical properties and, has a strong physical strength, fine and brilliant outer appearance. The nanostructured polyurethane leather is made by: using the feature of hard segment of PU to be a nanostructured material or the tie down point of the PU materials to bond nanometer particles to PU molecular chains or to directly add nanometer particles to PU resins, forming a nanometer structured PU of modulus 100% within 60˜150 kg/cm . According to one embodiment of the present invention, the nanometer structured polyurethane leather fabrication method comprises the steps of (a) mixing hard segment 4 Moles and soft segment 1 mole with MEK (methyl ethyl ketone) and DMF (Dimethylforamide) at 70˜90° for about 5 hours for reaction, (b) adding TEA (triethylamine) to the reacting mixture and mixing the mixture continuously for about 30 minutes, (c) adding EDA (chain extender) 3 mores to the mixture, and (d) adding DMF to adjust the viscosity. According to another embodiment of the present invention, the nanostructured polyurethane leather fabrication method comprises the steps of (a) adding nanostructured filler (calcium carbonate, carbon black, hydrated aluminum salt, cellulose, kaolinite, meerschaum, bentonite, silicon oxide, titanium dioxide, graphite, etc.) to a predetermined amount of DMF (Dimethylfloramide) while stirring, (b) adding PU resins and surfactant to the mixture and mix the mixture thoroughly. According to still another alternate form of the present invention, the nanostructured polyurethane leather fabrication method comprises the step of using the double bond free radicals of soft segment polyl to bond a nanostructured filler to one free radical of soft segment polyl by graft polymerization, enabling said nanostructured filler to become a part of soft segment molecular chain, so that nanostructured particles are evenly dispersed in polyurethane material during soft segment and hard segment bonding reaction.

### BRIEF DESCRIPTION OF THE DRAWINGS

FIG. 1 is a schematic drawing showing the soft and hard segments molecular structure of polyurethane.

FIG. 2 is a schematic drawing showing segmented hard segments and soft segments molecular bonding structure of polyurethane.

FIG. 3 is an enlarged view of a grip tape structure according to the present invention.

FIG. 4 is a comparison table showing the physical differences between a polyurethane material made according to the present invention and a polyurethane material made according to the prior art.

FIG. 5 is quality comparison table between a polyurethane grip tape made according to the present invention and a polyurethane grip tape made according to the prior art.

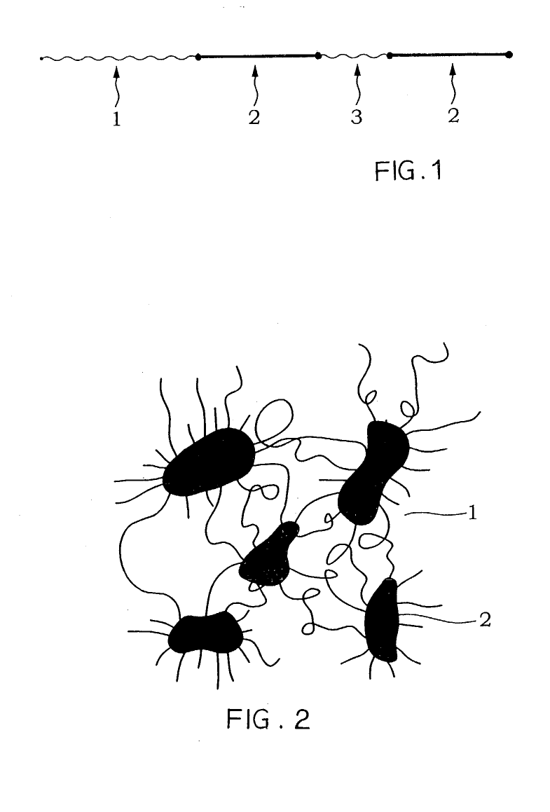

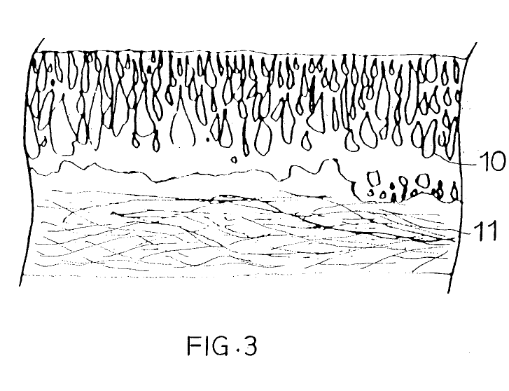

### DETAILED DESCRIPTION OF THE PREFERRED EMBODIMENT

Using the structure of the molecules of PU (polyurethane), PU hard segments are bonded into domains by means of Vander Waals force and hydrogen bonded interaction. The molecular length of each hard segment domain is about 2.5 nm˜15 nm, i.e., within “nanometer” for use as nanometer structured material or the tie down point of other nanometer structured. Hard segment domains thus obtained can be directly used as nanostructured materials. Alternatively, nanometer hard segment domains can be bonded to PU molecular chains or added to PU resin, enabling nanostructured hard segment domains to be evenly dispersed in soft segments. This invention uses the even dispersion feature of nanometer hard segment domains to develop a nanometer PU material suitable for making synthetic leathers for handle grip (grip tape or handlebar tube).

### EXAMPALE 1

Mix hard segment moles 4, soft segment moles 1 (most preferably, hard segment (including chain extender) 3˜6 Moles, soft segment 1 Mole) with MEK (methyl ethyl ketone) and DMF (Dimethylforamide) and then heat the mixture to 70˜90° for about 5 hours for reaction. When soft and hard segments proceeding the reaction, lower the temperature, and then add TEA (triethylamine) to the reacting mixture, and then mix the mixture continuously for about 30 minutes, and then add EDA (chain extender) moles 3 slowly, and then add DMF to adjust the viscosity, so as to obtain a PU material having modules about 90 kg/cm². This method uses nanostructured hard segment domains to make a PU chain bonding reaction with soft segments, enabling hard segments to be evenly dispersed in soft segments, i.e., this method achieves even dispersion of nanometer materials.

### EXAMPLE II

Add nanometer filler (calcium carbonate, carbon black, hydrated aluminum salt, cellulose, kaolinite, segmented meerschaum, bentonite, silicon oxide, titanium dioxide, graphite, etc.) to a proper amount of DMF (Dimethylfloramide) while stirring, and then add PU resins, surfactant, and pigment, and then mix the mixture thoroughly. As stated above, the molecule length of hard segment domains is about 2.5 nm˜15 nm that is within “nanometer” (1 nm˜100 nm). Hard segment domains can be the tie down point of the PU materials. Because added nanometer particles have a great contact area with PU resins, they can be bonded to PU resins, forming another strong tie down point and double-enhancing nanometer structured material properties.

### EXAMPLE III

Use the double bond free radicals of soft segment polyl to bond nanometer particles to one free radical of soft segment polyl by graft polymerization, enabling nanometer particles to become a part of the soft segment molecular chains. During soft segment and hard segment bonding reaction, nanometer particles are evenly dispersed in PU material.

According to any of the aforesaid three examples, a nanometer structured PU material having modules 100% within 60˜150 kg/cm² is obtained. The nanostructured PU material shows improved physical properties and high abrasion resistance. The surface of the nanometer structured PU material is fine and smooth. By means of adding natural or synthetic resins of low polymerization or low modulus to the nanometer structured PU material, the rough touch and low anti-skid power problems are eliminated

Mix the nanometer structured PU material thus obtained with a suitable amount of DMF (Dimethylforamide), surfactant, and pigment, and then use a coating knife to apply the mixture to a fiber base material (for example, nonwoven fabric), and then immerse the fiber base material in water, causing a replacement between water and DMF. After disappearance of DMF, the PU layer is coagulate on at the fiber base material, forming a microporous layer that has fine open spaces in it (see FIG. 3 where reference number 10 indicates the microporous layer; reference number 11 indicates the fiber base material). When the PU layer coagulated, the material is washed in 50˜60° C. hot water, and then dried, and a nanometer structured grip tape is thus obtained.

By means of displacement between DMF and water, the surface of the microporous layer 10 is not even. The projecting portions at the surface of the microporous layer 10 form a point of force upon gripping of the hand. Even the nanometer structured PU material is strong, the projecting portions can easily be damaged. In order to keep the surface smooth, calender the surface with calender rollers under 120˜150° C. When calendered, the surface becomes fine and smooth.

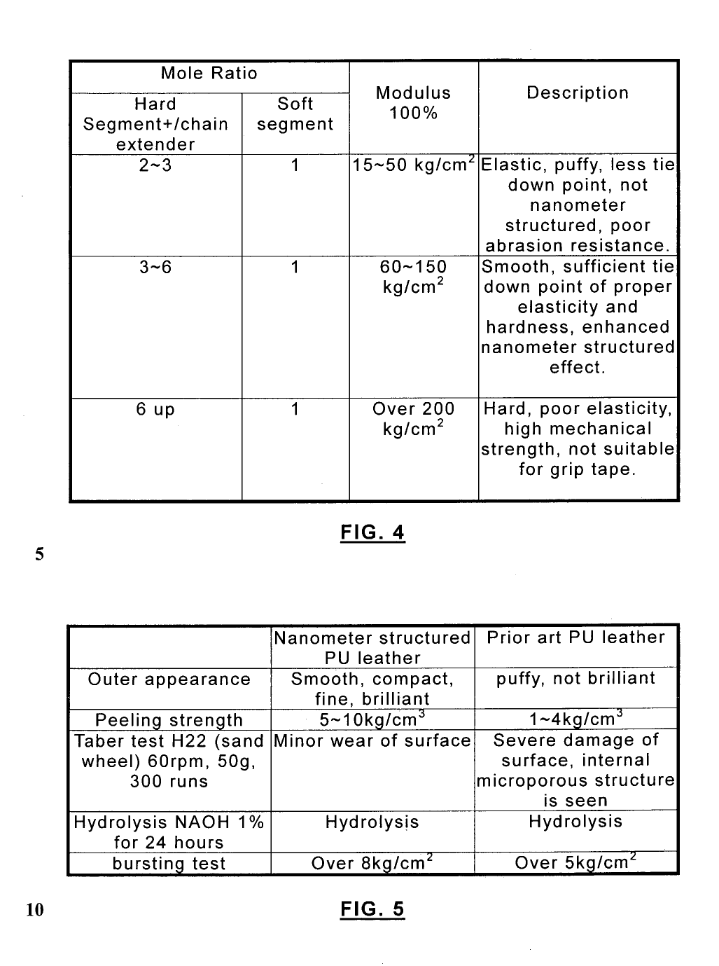

The physical properties of the aforesaid nanometer structured PU material are apparent in the comparison table of FIG. 4. According to the prior art design, hard segments (including chain extender) 2˜3 and soft segments 1 mole form a PU material of modulus 100% 15˜50 kg/cm². The PU material is elastic and sticky, having few nanometer structured tie down points. Therefore, this PU material is not nanometer structured, and the abrasion resistance of this PU material is low. When increasing hard segments (including chain extender) to 6 moles and maintaining soft segment at 1, a PU material of modulus % 60-150 kg/cm² is obtained that has excellent physical strength. However, due to a big amount of hard segments, most molecular chain lengths surpass 100 nm, the PU material thus obtained is stiff and less elastic, not within the range of “nanometer”. According to the present invention, hard segments (including chain extender) 3˜6 moles and soft segments 1 Mole form a nanometer structured PU material of modulus 100% 60˜150 kg/cm². Because hard segments are evenly dispersed in the PU material, the PU material shows a nanometer structured effect. Nanometer structured particles can be directly mixed in the PU material, or bonded to the PU material by polymerization. Because nanometer particles are evenly dispersed in the PU material, the PU material has a fine structure and high elasticity.

FIG. 5 shows a comparison between a nanometer structured PU grip tape of the present invention and a conventional PU grip tape of the prior art design. When viewing the outer appearance, the nanostructured PU grip tape is smooth, fine, brilliant, and compact. The conventional PU grip tape is puffy, and not brilliant.

With respect to peeling strength, the nanometer structured PU grip tape can sustain 5˜10 kg/cm³, and the conventional PU grip tape can only sustain 1˜4 kg/cm³.

With respect to the abrasion taber test at 60 rpm under 50 g for 1000 runs, the nanostructured PU grip tape shows minor wear on the surface, however the surface of the conventional PU grip tape is severely damaged, showing the internal microporous structure.

With respect to hydrolysis resisting power, hydrolysis is commonly seen in the nanometer structured PU grip tape and the conventional PU grip tape when immersed in NaOH 1% for 24 hours.

With respect to bursting teat, the nanometer structured PU grip tape surpasses 8 kg/cm², however the conventional PU grip tape is about 5 kg/cm² only.

As indicated above, the invention solves the problem of even dispersion of nanometer particles in PU materials. A nanometer structured PU material made according to the present invention show nanometer structured physical properties. A grip tape or handlebar tube made from a nanometer structured PU material according to the present invention has a high structural strength, high abrasion resistance, fine and smooth surface, and good slip function. All these features show superior to products made from conventional PU materials.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A nanometer structured synthetic leather made from polyurethane of segmented copolymer having soft segment and hard segment and chain extender, said soft segment being formed of high molecular weight polyol, said hard segment being formed of diisocyanate, said polyurethane comprising 3˜6 moles hard segment including chain extender and 1 mole soft segment, having modulus 100% within 50˜150 kg/cm³.

2. A nanometer structured synthetic leather fabrication method of making a nanostructured leather as claimed in claim 1, the method comprising the steps of (a) mixing hard segment 4 Moles and soft segment 1 Mole with MEK (methyl ethyl ketone) and DMF (Dimethylforamide) at 70˜90° for about 5 hours for reaction, (b) adding TEA (triethylamine) to the reacting mixture and mixing the mixture continuously for about 30 minutes, (c) adding EDA 3 Moles to the mixture, and (d) adding DMF to adjust the viscosity

3. The nanometer structured synthetic leather fabrication method as claimed in claim 1, wherein the modulus % of said polyurethane is most preferably at 90 kg/cm³.

4. A nanometer structured synthetic leather fabrication method of making a nanostructured leather as claimed in claim 1, the method comprising the steps of (a) adding nanometer filler (calcium carbonate, carbon black, hydrated aluminum salt, cellulose, kaolinite, segmented meerschaum, bentonite, silicon oxide, titanium dioxide, graphite) to a predetermined amount of DMF (Dimethylfloramide) while stirring, (b) adding PU resins and surfactant to the mixture and mix the mixture thoroughly.

5. The nanometer structured synthetic leather fabrication method as claimed in claim 4, wherein said nanostructured filler is calcium carbonate.

6. The nanometer structured synthetic leather fabrication method as claimed in claim 4, wherein said nanostructured filler is carbon black.

7. The nanometer structured synthetic leather fabrication method as claimed in claim 4, wherein said nanostructured filler is hydrated aluminum salt.

8. The nanometer structured synthetic leather fabrication method as claimed in claim 4, wherein said nanostructured filler is cellulose.

9. The nanometer structured synthetic leather fabrication method as claimed in claim 4, wherein said nanostructured filler is kaolinite.

10. The nanometer structured synthetic leather fabrication method as claimed in claim 4, wherein said nanostructured filler is segmented meerschaum.

11. The nanometer structured synthetic leather fabrication method as claimed in claim 4, wherein said nanostructured filler is bentonite.

12. The nanometer structured synthetic leather fabrication method as claimed in claim 4, wherein said nanostructured filler is silicon oxide.

13. The nanometer structured synthetic leather fabrication method as claimed in claim 4, wherein said nanostructured filler is titanium dioxide.

14. The nanometer structured synthetic leather fabrication method as claimed in claim 4, wherein said nanostructured filler is graphite.

15. A nanometer structured synthetic leather fabrication method of making a nanostructured leather as claimed in claim 1, the method comprising the step of using the double bond free radicals of soft segment polyol to bond a nanometer filler to one free radical of soft segment polyol by graft polymerization, enabling said nanometer filler to become a part of soft segment molecular chain, so that nanostructured particles are evenly dispersed in polyurethane material during soft segment and hard segment polymerization reaction.

16. The nanometer structured synthetic leather as claimed in claim 1, wherein said polyurethane contains a low molecular weight polymer (molecular weight under 2000 g).

17. The nanometer structured synthetic leather as claimed in claim 1, wherein said polyurethane contains a low modulus resin (modulus 100% under 20 kg/cm²).

18. The nanometer structured synthetic leather as claimed in claim 1, which is calendered for making a product.
